(19) United States
(12) Patent Application Publication
(10) Pub. No.: US 2008/0222365 A1
(43) Pub. Date: Sep. 11, 2008

(54) Managed Memory System

(75) Inventors: Leland Szewerenko, Austin, TX (US); Bert Haskell, Austin, TX (US)

Correspondence Address: FISH & RICHARDSON P.C., P.O BOX 1022, Minneapolis, MN, 55440-1022, US

(73) Assignee: STAKTEK GROUP L.P., Austin, TX (US)

(21) Appl. No.: 11/683,840

(22) Filed: Mar. 8, 2007

(51) Int. Cl. G06F 12/00

(52) U.S. Cl. 711/147

(57) ABSTRACT

A managed memory system is provided. More specifically, in one embodiment, there is provided a system including a memory device and a switch coupled to the memory device. The switch has at least a first switch position and a second switch position. The system also includes a memory controller coupled to the first switch position and a processor interface coupled to the second switch position.

### BACKGROUND

Managed memory modules are gaining wide use in a variety of different applications. Managed memory modules are memory modules that employ a dedicated memory controller that performs at least a portion of the memory management functions for the memory device on the memory module. For example, the memory controller can manage access to the memory devices, handle error correction, wear leveling, bad block management, and other administrative tasks for the memory devices.

Managed memory devices are now supplanting earlier-used memory and disk drive technologies in many processor-based systems, such as wireless phones and computers. In these devices, a separate boot memory is often directly connected to the processor to store boot code for the processor (including protocols/drivers for the memory controller). Eliminating this separate boot memory by consolidating the boot code into the memory devices would be desirable.

### SUMMARY

A managed memory system is provided. More specifically, in one embodiment, a system includes a memory device and switch coupled to the memory device. The switch has at least a first switch position and a second switch position. The system also includes a memory controller coupled to the first switch position and a processor interface coupled to the second switch position.

The details of one or more embodiments of the invention are set forth in the accompanying drawings and the description below.

### DESCRIPTION OF DRAWINGS

FIG. 1 is a block diagram of an example managed memory system in accordance with one embodiment.

FIG. 2 is a block diagram of another example managed memory system in accordance with one embodiment; and

FIG. 3 is a flow chart illustrating an exemplary technique for booting up a managed memory system in accordance with one embodiment.

Like reference symbols in the various drawings indicate like elements.

### DETAILED DESCRIPTION

The coupled controller includes a managed interface, a processor interface, and a switch that is coupled to the managed interface and the processor interface. The switch is configured to switch control of the one or more memory devices between the controller and a processor coupled to the processor interface.

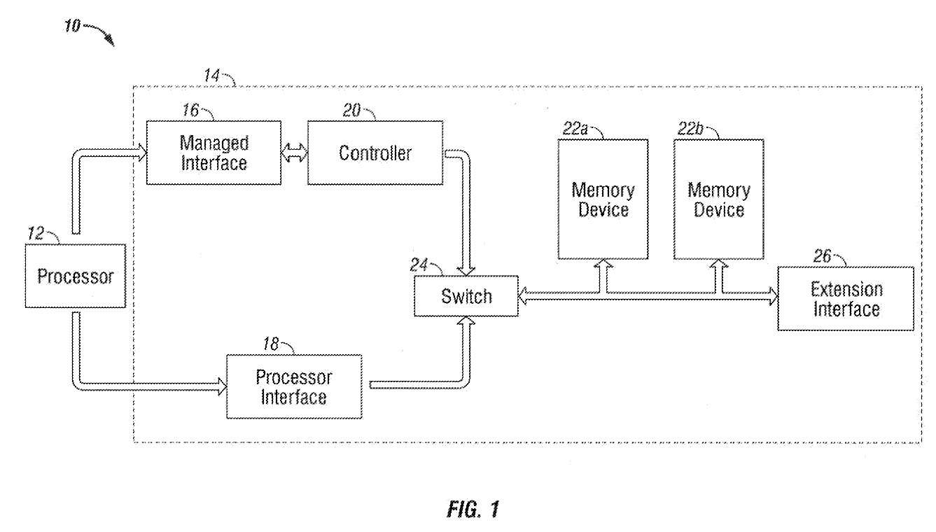

With reference to FIG. 1, a diagram of an example managed memory system 10 in accordance with one embodiment is illustrated. System 10 may be embodied in a variety of forms with a variety of separate components. For example, one embodiment includes a system on chip (“SOC”) while other embodiments are devised with one or more components mounted to one or more circuit boards or other substrates. The potential applications for system 10 include numerous computerized or electronic devices including, but not limited to, wireless phones, computers, laptops, personal digital assistants, expansion cards, computer based appliances, and consumer electronics devices.

The illustrated exemplar system 10 includes a processor 12 coupled to a memory module 14. Processor 12 may include any suitable form of processing unit. For example, in various configurations, processor 12 may include a central processing unit (“CPU”), a microprocessor, an application specific integrated circuit (“ASIC”), a field-programmable gate array (“FPGA”), or another suitable logic device. Processor 12 will typically have a raw memory interface from which it can boot.

In the illustrated example, processor 12 is coupled to memory module 14 through a managed interface 16 and a processor interface 18 within memory module 14. Managed interface 16 may be any of a variety of suitable interfaces for processing communications between processor 12 and a memory controller 20. Processor interface 18 may be an interface suitable for processing communications between processor 12 and memory devices. Processor interface 18 may provide the electrical and protocol equivalent of a raw memory interface from which processor 12 typically boots. Conversely, memory controller 20 provides managed interface 16 with support for a higher-level protocol that is typically error corrected, wear leveled, and bad-block corrected.

For example, in one configuration, processor interface 18 is a NAND flash memory interface provided by memory devices 22a and 22b. In an alternate example configuration, processor interface 18 includes an INTEL firmware hub (“FWH”) that permits direct booting of an X86 based processors through processor interface 18. As will be described further below, managed interface 16 may be used by processor 12 for memory requests that are to be handled by memory controller 20; whereas processor interface 18 is used for direct memory accesses by processor 12.

Although managed interface 16 and processor interface 18 are illustrated in FIG. 1 as two separate interfaces (e.g., two sets of wires, traces, or leads), managed interface 16 and processor interface 18 may, alternatively, include a single physical interface that is divided logically. For example, if the physical connection between processor 12 and memory module 14 is a plurality of leads, for example, processor interface 18 may include a subset of the leads and managed interface 16 may include all of the leads. Accordingly, processor interface 18 is employed by accessing only the subset of leads, and managed interface 16 is employed by accessing all of the leads.

Memory controller 20 may be any type of memory controller suitable to manage memory devices 22a and 22b. For example, memory controller 20 may, for example, be implemented with a multimedia card (“MMC”) controller, a secure digital (“SD”) controller, an AT attachment (“ATA”) controller, a serial ATA controller, a FLASH memory controller (either NOR or NAND), a serial FLASH controller, such as a serial peripheral interface (“SPI”) controller, and so forth. The above-listing of suitable memory controllers 20 is not intended to be exclusive.

Memory controller 20 is configured to receive memory access requests, such as READS and WRITES, from processor 12 over managed interface 16. Upon receiving a memory access request, memory controller 20 accesses memory device 22a or 22b associated with the memory request and performs the appropriate memory access (e.g., reading data from one or more of the memory devices 22a or 22b or writing data to one of the memory devices 22a or 22b). If the memory access was a read, memory controller 20 will then transmit the read data to processor 12, and if the memory access was a write, memory controller 20 may transmit a write status to processor 12 (e.g., success, failure, etc.).

In addition to handling memory access requests for processor 12, memory controller 20 may also be configured to manage the operation and use of memory devices 22a or 22b. For example, memory controller 20 can be configured to provide error correction functionality to memory devices 22a or 22b. Memory controller 20 may also be configured to remap memory blocks within memory devices 22a or 22b to spread write operations between the various sectors of memory devices 22a or 22b to promote even wear between the various sectors of memory devices 22a or 22b. This remapping is known as wear leveling. Memory controller 20 may also be configured to perform bad block management techniques that identify and avoid bad blocks within memory devices 22a or 22b. Moreover, memory controller 20 may also perform additional management functions for memory devices 22a or 22b.

Memory devices 22a or 22b may include any suitable type of semiconductor memory. In some configurations, memory devices 22a or 22b include NAND Flash memory. However, in other configurations, memory devices 22a or 22b include other suitable types of Flash memory, volatile memory, or non-volatile memory.

As shown in the example system of FIG. 1, memory module 14 includes a switch 24 coupled between memory devices 22a or 22b and both processor interface 18 and memory controller 20. In one configuration, switch 24 includes a multiplexer (i.e., a multiple input, single output switch). Switch 24 connects memory devices 22a or 22b to memory controller 20 when it is in a first position, and alternatively connects memory devices 22a or 22b to processor interface 18 when it is in a second position. In one configuration, the position of switch 24 is controlled by memory controller 20. However, in alternate configurations, the position of switch 24 may be controlled by another suitable component, such as processor 12 or another control system (not shown). Moreover, in still other embodiments, switch 24 may be replaced by any suitable form of electronic switch including, but not limited to, relays, latches, MOSFET switches, and gates.

Memory module 14 may also include an extension interface 26. Extension interface 26 is coupled to the same interfaces in the managed memory module as memory devices 22a or 22b and enables additional memory devices to be coupled to memory module 14 to increase the memory capacity of memory module 14. In some embodiments, memory module 14 includes multiple flash busses with flash memory devices attached to each bus. The use of multiple flash busses connected to the managed memory controller 20 provides for parallel transfers at a rate exceeding the capabilities of a single memory device 22a or 22b.

The extension interface 26 typically provides the electrical and protocol functions expected by a memory device 22a or 22b. These signals are duplicated by the number of parallel busses provided by the controller 20, which can typically be two or more (not shown). The extension interface 26 also may include chip select signals to allow selection of individual memory parts placed on a system board outside the memory module 14.

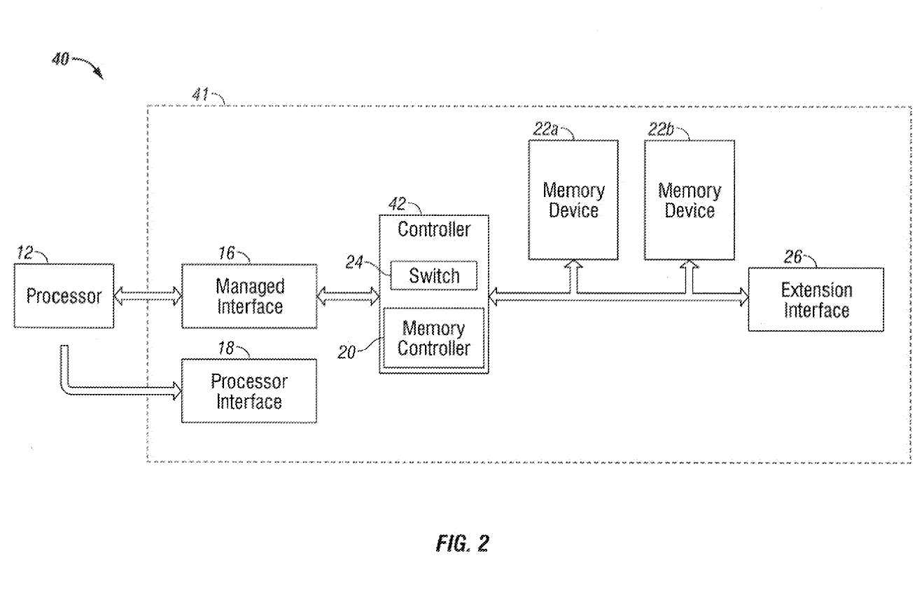

FIG. 2 is a block diagram of another example managed memory system 40 in accordance with one embodiment. As shown, system 40 may include processor 12 and a memory module 41. Memory module 41 may include managed interface 16, processor interface 18, memory devices 22a or 22b, and extension interface 26, as described above with regard to FIG. 1. In addition, memory module 41 also includes a controller 42, which is coupled between memory devices 22a or 22b and both managed interface 16 and processor interface 18. Controller 42 includes memory controller 20 and switch 24. In one embodiment, controller 42 includes a managed FLASH memory controller with an added FLASH interface. In this embodiment, controller 42 may be configured to bypass the FLASH memory controller if an input is received over the FLASH interface or vice versa.

As described above, systems 10 and 40 can be configured to switch access and control over memory devices 22a or 22b between processor 12 and memory controller 20 (via switch 24). Advantageously, in some configurations, this functionality may enable boot code for processor 12 to be stored on one or more of the memory devices 22a or 22b while, at the same time, enabling memory controller 20 to manage memory devices 22a or 22b during normal operations of system 10, for example. In particular, switch 24 may directly connect processor 12 to memory 22a at the start of boot-up sequence and then switch to connecting memory controller 2 and memory 22a later in the boot-up sequence. This functionality may relieve the requirement for a separate boot memory for processor 12, thus, potentially reducing the complexity and/or cost of system 10, for example.

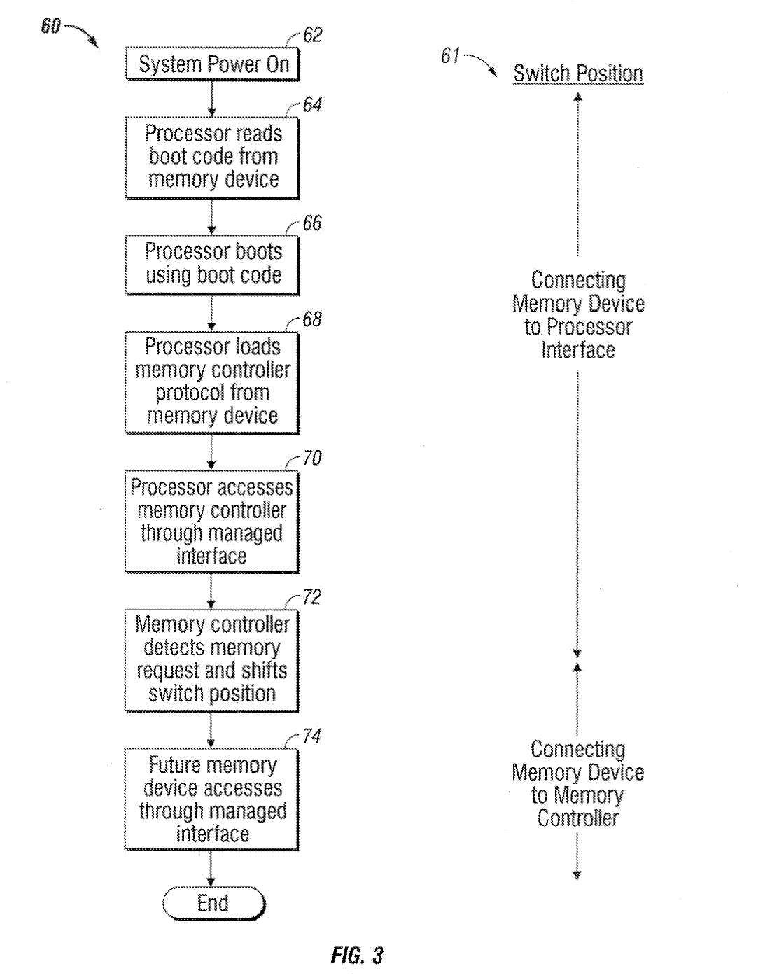

FIG. 3 is a flow chart illustrating an exemplary technique 60 for booting up a managed memory system in accordance with one embodiment. Technique 60 can be executed by system 10, by system 40, or by another suitable managed memory module. As indicated by block 62 of FIG. 3, technique 60 may begin with a system being powered on. Powering on the system may include a cold startup of the system, a soft reset, a hard reset, or any other action that causes a processor to begin a bootstrapping process or boot sequence.

Next, the processor may read boot code from a memory device over a processor interface, as indicated by block 64. For example, processor 12 may read row zero from memory device 22a over processor interface 18. Alternatively, the processor may be configured to read the boot code from any other suitable memory location within the memory devices 22a or 22b. As indicated by FIG. 3, this direct read of the memory device by the processor is possible because the switch, such as switch 24, is connecting the memory device to the processor interface at this point in the boot sequence, as indicated by column 61 of FIG. 3. This operation is possible because the managed memory module 14 supplies the same processor interface as the boot memory that the processor 12 was designed to boot from.

After reading the boot code, the processor may boot using the boot code, as indicated by block 66. At some point during the boot process, the processor will load a memory controller protocol from the memory device and initialize a memory controller, such as memory controller 20. After initializing the memory controller, the processor may access the memory controller and, thus, the memory device through managed interface, as indicated by block 70.

When the memory controller detects the memory request for the memory devices being received through the managed interface, the memory controller or another suitable control system may shift the position of the switch to connect the memory device to the memory controller, as indicated by block 72. In some embodiments, the position of the switch may alternatively be shifted when the memory controller is initialized. After the switch has connected the memory controller to the memory devices, future memory requests are processed through the memory controller (e.g., through managed interface 16), as indicated by block 74.

There are also provided methods and techniques for assembling some or all of the system 10 or the system 40. For example, in one embodiment, there is provided a method of manufacturing a memory module, the method including providing a memory device and coupling the controller to the memory device, wherein the controller has a managed interface, a processor interface, and a switch coupled to the managed interface and the processor interface. The switch in this technique is configured to switch a connection to the memory device between the managed interface and the processor interface. This technique may also include coupling the processor interface to the processor and coupling the managed interface to the processor.

In another embodiment, there is provided a technique for manufacturing a memory module that includes providing a memory device, coupling the memory device to a switch having at least a first switch position and a second switch position, coupling a memory controller to the first switch position, and coupling a processor interface coupled to the second switch position.

It will be seen by those skilled in the art that many embodiments taking a variety of specific forms and reflecting changes, substitutions, and alternations can be made without departing from the spirit and scope of the invention. Therefore, the described embodiments illustrate but do not restrict the scope of the claims.

What is claimed is:

1. A device comprising:
a memory device; and
a controller coupled to the memory device, the controller comprising:
a managed interface;
a processor interface; and
a switch coupled to the managed interface and the processor interface, the switch configured to switch control of the memory device between the controller and a processor coupled to the processor interface.

2. The device of claim 1, wherein the managed interface comprises a multimedia card interface.

3. The system of claim 1, wherein the switch comprises a multiplexer.

4. The system of claim 1, wherein the processor interface comprises a NAND flash memory interface.

5. The system of claim 4, wherein the managed interface comprises a multimedia card controller.

6. The system of claim 1, wherein the controller comprises a secure digital controller.

7. The system of claim 1, comprising an expansion interface coupled to the memory controller

8. The system of claim 1, comprising a processor coupled to the processor interface.

9. The system of claim 8, wherein the memory device stores boot code for a processor.

10. The system of claim 8, wherein the system comprises a system on chip device.

11. A system comprising:
a memory device;
a switch coupled to the memory device and having at least a first switch position and a second switch position;
a memory controller coupled to the first switch position; and
a processor interface coupled to the second switch position.

12. The device of claim 11, wherein the memory controller comprises a multimedia card controller.

13. The device of claim 12, wherein the processor interface comprises a NAND flash memory interface.

14. The device of claim 11, wherein the memory device stores boot code for the processor.

15. A method comprising:
receiving a memory access request from a processor for a flash memory device; and
changing the position of a switch in response to the memory access, wherein the switch is located between the flash memory device and both the processor and a memory controller.

16. The method of claim 15 in which the memory controller is a multimedia card controller.

17. The method of claim 15, wherein the changing the position of the switch comprises changing the position of a multiplexer.

18. The method of claim 15 wherein receiving the memory access request comprises receiving the memory access request over a managed interface between the memory controller and the processor.

19. A method comprising:
loading a memory controller protocol directly from a flash memory device, wherein loading the memory controller protocol enables communication through the memory controller; and
sending a memory access request for the flash memory device to the memory controller.

20. The method of claim 19, wherein loading the memory controller protocol comprises accessing a row 0 of the flash memory device.

21. The method of claim 19, wherein loading the memory controller protocol comprises loading a multimedia card protocol.

22. A method of manufacturing a memory module, the method comprising:
providing a memory device; and
coupling a controller to the memory device, wherein the controller has a managed interface, a processor interface, and a switch coupled to the managed interface and the processor interface, wherein the switch is configured to switch a connection to the memory device between the managed interface and the processor interface.

23. The method of claim 22, comprising coupling the processor interface to a processor.

24. The method of claim 23, comprising coupling the managed interface to the processor.

25. The method of claim 23, wherein coupling the processor interface comprises coupling a NAND flash memory interface to the processor.
